(19) United States
(12) Patent Application Publication
(10) Pub. No.: US 2009/0208636 A1
(43) Pub. Date: Aug. 20, 2009

(54) METHOD FOR PRODUCING LIGHT-ABSORBING LAYER FOR SOLAR CELL

(75) Inventor: In-hwan Choi, Seoul (KR)

Correspondence Address: OBLON, SPIVAK, MCCLELLAND MAIER & NEUSTADT, P.C., 1940 DUKE STREET, ALEXANDRIA, VA, 22314, US

(73) Assignee: In-Solar Tech Co., Ltd, Seoul (KR)

(21) Appl. No.: 12/305,383

(22) PCT Filed: Jun. 19, 2007
(86) PCT No.: PCT/KR2007/002961

§ 371 Date: Dec. 18, 2008

(30) Foreign Application Priority Data
Jun. 19, 2006 (KR) 10-2006-0055064

(51) Int. Cl. B05D 5/12

(52) U.S. Cl. 427/76

(57) ABSTRACT

Disclosed herein is a method for producing a light-absorbing layer for a solar cell that is capable of economically and efficiently forming an I-III-VI₂ compound thin film used as a light-absorbing layer for a solar cell. The method comprises (a) depositing a single precursor including Group III and VI elements on a substrate by metal organic chemical vapor deposition (MOCVD) to form a Group III-VI or III₂-VI₃ compound thin film, (b) depositing a precursor including a Group I element on the III-VI or III₂-VI₃ compound thin film by MOCVD to form a I-III-VI compound thin film composed of Group I, III and VI elements, and (c) heating the I-III-VI compound thin film under a Group VI element-containing gas atmosphere or depositing a Group VI element-including precursor on the I-III-VI compound thin film by MOCVD to form an I-III-VI₂ compound thin film.

### BACKGROUND OF THE INVENTION

1. Field of the Invention

The present invention relates to a method for producing a light-absorbing layer for a solar cell. More specifically, the present invention relates to a method for producing a light-absorbing layer for a solar cell that is capable of economically and efficiently forming an I-III-VI₂ compound thin film used as a light-absorbing layer for a solar cell.

2. Description of the Related Art

Ternary thin films composed of I-III-VI₂ compounds such as CuInSe₂ (hereinafter, referred to as a “CIS”) and CuIn₁₋ₓGaₓSe₂ (hereinafter, referred to as a “CIGS”) are compound semiconductors being actively researched for use as light-absorbing layers for solar cells. CIS thin film solar cells have advantages in that they can be produced to a thickness of 10 microns or less and exhibit superior long-term stability, as compared to conventional crystalline silicon solar cells. In addition, since CIS thin film solar cells have experimental maximum energy conversion efficiencies (i.e. 19.5%) higher than those of other thin film solar cells, they have the significantly great possibility of commercialization as low-cost high-efficiency solar cells that are capable of substituting crystalline silicon solar cells.

Accordingly, a variety of methods for producing CIS thin films were suggested. For example, U.S. Pat. No. 4,523,051 discloses a method for depositing elements on a substrate by simultaneous vaporization under a vacuum atmosphere. However, this method is disadvantageously uneconomic in view of the impossibilities of realization of large-area and mass-production. Meanwhile, U.S. Pat. No. 4,798,660 discloses deposition of a Cu—In thin film by sputtering and selenization of the Cu—In thin film by heating under a selenium-containing gas atmosphere (e.g. H₂Se). This method is being commonly used owing to its suitability for realization of large-area and mass-production. However, by this method, it is impossible to produce high-quality multilayer thin films. Other methods such as electrodeposition, molecular beam epitaxy (MBE) and the like were suggested, but they are incapable of producing high-quality multilayer thin films or are uneconomic, thus being unsuitable for common use.

Accordingly, in order to produce high-quality CIS thin films on a large scale, it is the most preferable to use metal organic chemical vapor deposition (hereinafter, referred to as “MOCVD”) which is widely used in conventional semiconductor processing. MOCVD is the most general method in semiconductor industries that is capable of producing high-quality thin films in lower costs. However, the production of the CIS solar cell absorbing layers by MOCVD using conventional precursors present problems in that the absorbing layers are difficult to produce, and reagents are used in a unnecessarily excessive amount, thus being uneconomic in view of mass-production.

KR Patent Nos. 495,924 and 495,925 issued to the present applicant disclose a method for producing a desired stoichiometric ratio of I-III-VI₂ compound thin films (e.g. CuInSe₂ thin film) by a MOCVD technique employing a proper precursor. According to the methods, the CuInSe₂ thin film is produced by forming an InSe thin film on a Mo substrate using an In—Se precursor, depositing Cu on the InSe thin film to form a Cu₂Se thin film and feeding an InSe source onto the Cu₂Se thin film to form CuInSe₂ thin film. This method is capable of easily producing a substantial stoichiometric ratio of high-quality thin films in a simple process, but has a problem of the unnecessarily excessive use of a high-priced Group III element (e.g. In).

### SUMMARY OF THE INVENTION

Therefore, the present invention has been made in view of the above problems of the prior art, and it is one object of the present invention to provide a method for producing a light-absorbing layer for a solar cell that is capable of producing a substantial stoichiometric ratio of a high-quality I-III-VI₂ compound thin film without unnecessary waste of a Group III element.

In accordance with one aspect of the present invention for achieving the above objects, there is provided a method for producing a light-absorbing layer for a solar cell by forming a I-III-VI₂ compound thin film on a substrate comprising: (a) depositing a single precursor including Group III and VI elements on a substrate by metal organic chemical vapor deposition (MOCVD) to form a Group III-VI or III₂-VI₃ compound thin film; (b) depositing a precursor including a Group I element on the III-VI or III₂-VI₃ compound thin film by MOCVD to form a thin film composed of Group I, III and VI elements (hereinafter, referred to as a “I-III-VI compound thin film”); and (c) heating the I-III-VI compound thin film under a Group VI element-containing gas atmosphere or depositing a Group VI element-including precursor on the I-III-VI compound thin film by MOCVD to form an I-III-VI₂ compound thin film.

The method may further comprise (d) depositing a single precursor including a Group III′ or VI′ element different from the Group III or VI element of the single precursor used in step (a) on the I-III-VI₂ compound thin film formed in step (c) by MOCVD to form a I-III₁₋ₓIII′ₓ-VI₂, I-III-(VI_{1-y}VI′_{y})₂, or I-III₁₋ₓIII′ₓ-(VI_{1-y}VI′_{y})₂ compound thin film (wherein x and y are 0≦(x,y)≦1).

The method may further comprise (d) depositing a precursor including only Group III′ element different from the Group III element of the single precursor used in step (a) on the I-III-VI₂ compound thin film formed in step (c) by MOCVD to form a I-III₁₋ₓIII′ₓ-VI₂ (0≦x≦1) compound thin film.

The method may further comprise (d) depositing a precursor including only Group VI′ element different from the Group VI element of the single precursor used in step (c) on the I-III-VI₂ compound thin film formed in step (c) by MOCVD to form a I-III-(VI_{1-y}VI′_{y})₂ (0≦y≦1) compound thin film.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic diagram illustrating a process for producing a CuInSe₂ thin film according to one embodiment of the present invention;

FIG. 2 is a schematic diagram illustrating a process for producing a CuIn₁₋ₓGaₓSe₂ thin film according to another embodiment of the present invention;

FIG. 3 is a graph showing variations in X-ray diffraction (XRD) patterns of thin films according to a production process in Examples of the present invention, specifically, (a) is XRD patterns of an InSe thin film, (b) is XRD patterns of a thin film obtained by depositing Cu on the InSe thin film, (c) is XRD patterns of a CuInSe₂ thin film obtained by heating the thin film (b) under a H₂Se gas atmosphere, and (d) is XRD patterns of a CuIn_{0.66}Ga_{0.34}Se₂ thin film obtained by depositing GaSe on the thin film (c); and

FIG. 4 is a graph showing variations in Raman spectra of thin films according to a production process in Examples of the present invention, and specifically, (a) is Raman spectra of an InSe thin film, (b) is Raman spectra of a thin film obtained by depositing Cu on the InSe thin film, (c) is Raman spectra of a CuInSe₂ thin film obtained by heating the thin film (b) under a H₂Se gas atmosphere, and (d) is Raman spectra of a CuIn_{0.66}Ga_{0.34}Se₂ thin film obtained by depositing GaSe on the thin film (c).

### DESCRIPTION OF THE PREFERRED EMBODIMENTS

The present invention will now be described in greater detail.

According to the present invention, the light-absorbing layer for a solar cell is obtained by producing an I-III-VI₂ compound thin film on a substrate. A method for producing the I-III-VI₂ compound thin film comprises (a) depositing a single precursor including Group III and VI elements on a substrate by metal organic chemical vapor deposition (MOCVD) to form a Group III-VI or III₂-VI₃ compound thin film; (b) depositing a precursor including a Group I element on the III-VI or III₂-VI₃ compound thin film by MOCVD to form a I-III-VI compound thin film composed of Group I, III and VI elements; and (c) heating the I-III-VI compound thin film under a Group VI element-containing gas atmosphere or depositing a Group VI element-including precursor on the I-III-VI compound thin film by MOCVD to form an I-III-VI₂ compound thin film.

The Group I element that can be used in the present invention includes copper (Cu) or silver (Ag), and covers all elements which belong to Group I of the Periodic Table. The Group III element that can be used in the present invention includes aluminum (Al), gallium (Ga) or indium (In), and covers all elements which belong to Group III of the Periodic Table. The Group VI element that can be used in the present invention includes selenium (Se), sulfur (S) or tellurium (Te), and covers all elements which belong to Group VI of the Periodic Table. Preferably, the Group I element is Cu or Ag, the Group III element is selected from In, Ga and Al, and the Group VI element is selected from Se, Te and S.

Metal organic chemical vapor deposition (hereinafter, referred to as “MOCVD”) is generally used to form a thin film on a substrate. In the present invention, thin films are formed using a low-pressure MOCVD system which is commonly used in the art.

Examples of the substrate that can be used in the present invention include substrates, where a molybdenum (Mo) metal is deposited on a general glass substrate, and substrates, where a Mo metal is deposited on a film composed of a thin flexible stainless steel or a high heat-resistance polymer (e.g. Kapton or polimide). If needed, substrates well-known in the art can be used herein.

The step (a) for producing the thin film used as a solar cell light-absorbing layer is to form a III-VI or III₂-VI₃ compound thin film by depositing a single precursor including a Group III or VI element on a substrate by MOCVD.

In step (a), the single precursor including a Group III or VI element may be selected from single precursors commonly used in the art. For example, there may be mentioned a single precursor having a structure of [R₂M(μ-ER′)]₂, wherein M is a Group III element selected from In, Ga and Al; R and R′ are each independently C₁-C₆ alkyl; E is a Group VI chalcogen element selected from S, Se and Te; and μ is a double bridge between the Group VI element and the Group III element. Specific examples of [R₂M(μ-ER′)]₂ include [Me₂In(μ-SeMe)]₂, [Me₂Ga(μ-SeMe)]₂, [Me₂In(μ-SMe)]₂, [Me₂Ga(μ-SMe)]₂, [Me₂In (μ-TeMe)]₂, [Me₂Ga(μ-TeMe)]₂, [Et₂In(μ-SeEt)]₂, [Et₂Ga(μ-SeEt)]₂, [Et₂In(μ-TeEt)]₂ and [Et₂In(μ-SEt)]₂—In the Formulas, Me is methyl and Et is ethyl.

Furthermore, the single precursor is not necessarily limited to those as mentioned above and those skilled in the art will appreciate that the use of other single precursors is possible.

The thin film formed on the substrate using the afore-mentioned single precursor may be represented by the following structural formula: InSe, GaSe, AlSe, InS, GaS, AlS, InTe, GaTe or AlTe; or In₂Se₃, Ga₂Se₃, Al₂Se₃, In₂S₃, Ga₂S₃, Al₂S₃, In₂Te₃, Ga₂Te₃ or Al₂Te₃.

The step (b) for producing the thin film used as a solar cell light-absorbing layer is to form an I-III-VI compound thin film composed of Group I, III and VI elements by depositing a precursor including a Group I metal on the Group III-VI or III₂-VI₃ compound thin film by MOCVD.

In step (b), it is essential that the deposition of the precursor on the III-VI or III₂-VI₃ compound thin film by MOCVD should be carried out at a substrate temperature as low as possible. The reason is that for example, in a case of growth of a CIS thin film, when Cu is deposited on a grown InSe thin film at a high substrate temperature by MOCVD, In is dissociated from InSe and lost, and ultimately, a Cu₂Se thin film is thus created. Accordingly, in order to minimize loss of the Group III element, it is preferable that the process of step (b) is carried out at a low substrate temperature. Preferably, the substrate temperature is controlled within a range from the lowest dissociation temperature of the Group I metal-including precursor to the temperature at which Group III elements are dissociated on the substrate. If possible, the Group I element-including precursor is preferably selected from those that are dissociated at a low temperature. In particular, the Group I element-including precursor is a monovalent or divalent precursor. Among known precursors, monovalent precursors are preferably used because of relatively low dissociation temperature. For example, in a case where the Group I metal-including precursor is a monovalent Cu precursor, the deposition is preferably carried out at a substrate temperature of 100 to 300° C.

The Group I metal-including precursor may be selected from those that are used commonly in the art. For example, a precursor having a structure of (hfac)I(DMB) may be used as a monovalent Cu precursor. In the structural formula, hfac is an abbreviation for hexafluoroacetylaceto and DMB is an abbreviation for 3,3-dimethyl-1-butene. Furthermore, the precursor including a Group I metal is not necessarily restricted and those skilled in the art will appreciate that the use of other single precursors is possible.

In the deposition of a Group I metal by MOCVD using the Group I metal-including precursor, a ratio of a Group III element to a Group I element ([I]/[III]) is preferably adjusted to be slightly lower than 1, while taking into consideration the fact that the Group III element is evaporated and lost in the heating process of the following step (c).

After formation of the I-III-VI compound thin film in step (b), the I-III-VI compound thin film is heated under a Group VI element-containing gas atmosphere or a Group VI metal-including precursor is deposited on the I-III-VI compound thin film by MOCVD to form an I-III-VI₂ compound thin film (step (c)).

The Group VI element-containing gas includes gases that have a structure of H₂E (wherein, E is a Group VI chalcogen element such as Se, S or Te). Specifically, the Group VI element-containing gas is selected from H₂S, H₂Se and H₂Te. For example, H₂Se is used to form a selenium (Se) compound such as CuInSe₂. The heating is carried out at a temperature higher than the dissociation temperature of the selected gas. That is, when the heating is carried out at about 150° C., i.e. the dissociation temperature of H₂Se, selenium (Se) can be supplemented. However, to obtain a compound thin film with excellent crystallinity, the heating temperature is preferably about 300 to about 500° C. In particular, when the Group VI element is supplemented using the H₂VI-type gas, a high-quality thin film can be advantageously formed at considerably low costs and high speed, as compared to conventional methods.

In step (c), instead of using the Group VI element-containing gas, there may be employed deposition of a precursor that have a structure of R₂E (wherein E is a Group VI chalcogen element selected from S, Se and Te; and R is C₁-C₆ alkyl) used commonly in the art on the I-III-VI compound thin film by MOCVD. Examples of the R₂E precursor include (C₂H₅)₂Se, (CH₃)₂Se, (C₂H₅)₂S, (CH₃)₂S, (C₂H₅)₂Te and (CH₃)₂Te, and those skilled in the art will appreciate that the use of other single precursors is possible. Examples of the I-III-VI₂ compound thin film thus formed include CuAlSe₂, CuGaSe₂, CuInSe₂, AgAlSe₂, AgGaSe₂, AgInSe₂, CuAlS₂, CuGaS₂, CuInS₂, AgAlS₂, AgGaS₂, AgInS₂, CuAlTe₂, CuGaTe₂, CuInTe₂, AgAlTe₂, AgGaTe₂ and AgInTe₂. Those skilled in the art will appreciate that the use of other single precursors is possible. In brief, the reason is that elements which belong to the same Group on the Periodic Table have similar properties to one another.

The I-III-VI₂ compound thin film obtained by the method of the present invention is useful for a light-absorbing layer for solar cells. The method of the present invention has advantages in that a high quality thin film can be produced at low costs, as compared to conventional methods for forming CIS absorbing layers for solar cells.

The method of the present invention may further comprise (d) depositing a single precursor including a Group III′ or VI′ element different from the Group III or VI element of the single precursor used in step (a) on the I-III-VI₂ thin film formed in step (c) by MOCVD to form a I-III₁₋ₓIII′ₓ-VI₂, I-III-(VI₁₋ₓVI′ₓ)₂, or I-III₁₋ₓIII′ₓ-(VI_{1-y}VI′_{y})₂ compound thin film (wherein x and y are 0≦(x,y)≦1).

When a single precursor including the Group III′ or VI′ element different from that used in step (a) is deposited on the I-III-VI₂ compound thin film by MOCVD, the Group III or VI element moiety of the I-III-VI₂ compound thin film formed in step (c) is replaced with the III′ or VI′ element. More specifically, upon comparing the single precursor used in step (d) with that in step (a), in a case where a Group III element of the single precursor in step (d) is different from that in step (a) and a Group VI element of the single precursor in step (d) is identical to that in step (a), an I-III₁₋ₓIII′ₓ-VI₂ compound thin film is formed. In a case where a Group III element of the single precursor in step (d) is identical to that in step (a) and a Group VI element of the single precursor in step (d) is different from that in step (a), an I-III-(VI_{1-y}VI′_{y})₂ compound thin film is formed. In a case where both a Group III element and a Group VI element of the single precursor in step (d) are identical to those in step (a), an I-III₁₋ₓIII′ₓ-(VI_{1-y}VI′_{y})₂ compound thin film is formed. In these formulas, x and y are 0≦(x,y)≦1.

Similar to the single precursor in step (a), the single precursor including a Group III′ or VI′ element in step (d) may be selected from those that have a structure of [R₂M(μ-ER′)]₂, wherein M is a Group III element selected from In, Ga and Al; R and R′ are each independently C₁-C₆ alkyl; E is a Group VI chalcogen element selected from S, Se and Te; and p is a double bridge between the Group VI element and the Group III element. Specific examples of [R₂M(μ-ER′)]₂ include [Me₂In(μ-SeMe)]₂, [Me₂Ga(μ-SeMe)]₂, [Me₂In(μ-SMe)]₂, [Me₂Ga(μ-SMe)]₂, [Me₂In(μ-TeMe)]₂, [Me₂Ga(μ-TeMe)]₂, [Et₂In(μ-SeEt)]₂, [Et₂Ga(μ-SeEt)]₂, [Et₂In(μ-TeEt)]₂ and [Et₂In(μ-SEt)]₂, provided only that the single precursor in step (d) is different from that of step (a). Those skilled in the art will appreciate that the use of other single precursors is possible.

Examples of the compound thin film thus formed include CuIn₁₋ₓGaₓSe₂, CuIn₁₋ₓAlₓSe₂, CuGa₁₋ₓAlₓSe₂, AgIn₁₋ₓGaₓSe₂, AgIn₁₋ₓAlₓSe₂, AgIn₁₋ₓGaₓSe₂, CuIn₁₋ₓGaₓS₂, CuIn₁₋ₓAlₓS₂, CuGa₁₋ₓAlₓS₂, AgIn₁₋ₓGaₓS₂, AgIn₁₋ₓAlₓS₂, AgIn₁₋ₓGaₓS₂, CuIn₁₋ₓGaₓTe₂, CuIn₁₋ₓAlₓTe₂, CuGa₁₋ₓAlₓTe₂, AgIn₁₋ₓGaₓTe₂, AgIn₁₋ₓAlₓTe₂, AgIn₁₋ₓGaₓTe₂, CuIn(Se,S)₂, CuGa(Se,S)₂, AgIn(Se,S)₂, AgGa(Se,S)₂, CuIn(Se,Te)₂, CuGa(Se,Te)₂, AgIn(Se,Te)₂, AgGa(Se,Te)₂, CuIn(S,Te)₂, CuGa(S,Te)₂, AgIn(S,Te)₂ and AgGa(S,Te)₂. Those skilled in the art will appreciate that the use of other single precursors is possible.

The method of the present invention may further comprise d) depositing a single precursor including only a Group III′ element different from the Group III element of the single precursor used in step (a) on the I-III-VI₂ thin film formed in step (c) by MOCVD to form a I-III₁₋ₓIII′ₓ-VI₂ compound thin film (wherein x and y are 0≦(x,y)≦1).

When such a single precursor is used, the Group III element moiety of the I-III-VI₂ compound thin film formed in step (c) is replaced with the III′ element to form an I-III₁₋ₓIII′ₓ-VI₂ compound thin film (wherein x and y are 0≦(x,y)≦1).

The precursor that can be used herein is selected from those that have a structure of R₃M (wherein R is C₁-C₆ alkyl and M is a Group III element selected from Al, In and Ga). For example, the R₃M precursor is selected from (C₂H₅)₃Al (i.e. TEtAl), (CH₃)₃Al (i.e. TMeAl), (C₂H₅)₃In (i.e. TEtIn), (CH₃)₃In (i.e. TMeIn), (C₂H₅)₃Ga (i.e. TEtGa) and (CH₃)₃Ga (i.e. TMeGa), wherein TMe is tri-methyl and TEt is tri-ethyl.

Examples of the thin film thus formed include CuIn₁₋ₓGaₓSe₂, CuIn₁₋ₓAlₓSe₂, CuGa₁₋ₓAlₓSe₂, AgIn₁₋ₓGaₓSe₂, AgIn₁₋ₓAlₓSe₂, AgIn₁₋ₓGaₓSe₂, CuIn₁₋ₓGaₓS₂, CuIn₁₋ₓAlₓS₂, CuGa₁₋ₓAlₓS₂, AgIn₁₋ₓGaₓS₂, AgIn₁₋ₓAlₓS₂, AgIn₁₋ₓGaₓS₂, CuIn₁₋ₓGaₓTe₂, CuIn₁₋ₓAlₓTe₂, CuGa₁₋ₓAlₓTe₂, AgIn₁₋ₓGaₓTe₂, AgIn₁₋ₓAlₓTe₂, and AgIn₁₋ₓGaₓTe₂.

The method of the present invention may further comprise d) depositing a single precursor including only Group VI′ element different from the Group VI element of the single precursor used in step (a) on the I-III-VI₂ thin film formed in step (c) by MOCVD to form a I-III-(VI_{1-y}VI′_{y})₂ compound thin film (wherein x and y are 0≦(x,y)≦1).

When such a single precursor is used, the Group VI element moiety of the I-III-VI₂ compound thin film formed in step (c) is replaced with the VI′ element to form an I-III-(VI_{1-y}VI′_{y})₂ (0≦y≦1) compound thin film.

The precursor that can be used herein is selected from those that have a structure of R₂E (wherein E is a Group VI chalcogen element selected from S, Se and Te; and R is C₁-C₆ alkyl). Specifically, the R₂E precursor is selected from (C₂H₅)₂Se, (CH₃)₂Se, (C₂H₅)₂S, (CH₃)₂S, (C₂H₅)₂Te and (CH₃)₂Te, and those skilled in the art will appreciate that the use of other single precursors is possible.

Examples of the thin film thus formed include CuIn(Se,S)₂, CuGa(Se,S)₂, AgIn(Se,S)₂, AgGa(Se,S)₂, CuIn(Se,Te)₂, CuGa(Se,Te)₂, AgIn(Se,Te)₂, AgGa(Se,Te)₂, CuIn(S,Te)₂, CuGa(S,Te)₂, AgIn(S,Te)₂ and AgGa(S,Te)₂.

After the deposition of step (d) on the I-III-VI₂ compound thin film obtained in step (c) mentioned above is performed, a thin film suitable for use as a light-absorbing layer for a solar cell is obtained. The method of the present invention has advantages in that a high quality thin film can be produced at considerably low costs, as compared to conventional methods for forming CIS absorbing layers for solar cells.

Hereinafter, the present invention will be explained in more detail with reference to the following examples.

However, these examples are given for the purpose of illustration and are not to be construed as limiting the scope of the invention.

### EXAMPLES

### Example 1

A bubbler, in which [Me₂In(μ-SeMe)]₂ and (hfac)Cu(DMB) precursors are included, and a H₂Se gas feeder were sequentially mounted to a low-pressure MOCVD system. On operating the bubbler and the gas feeder, a CIS thin film was produced in the following process.

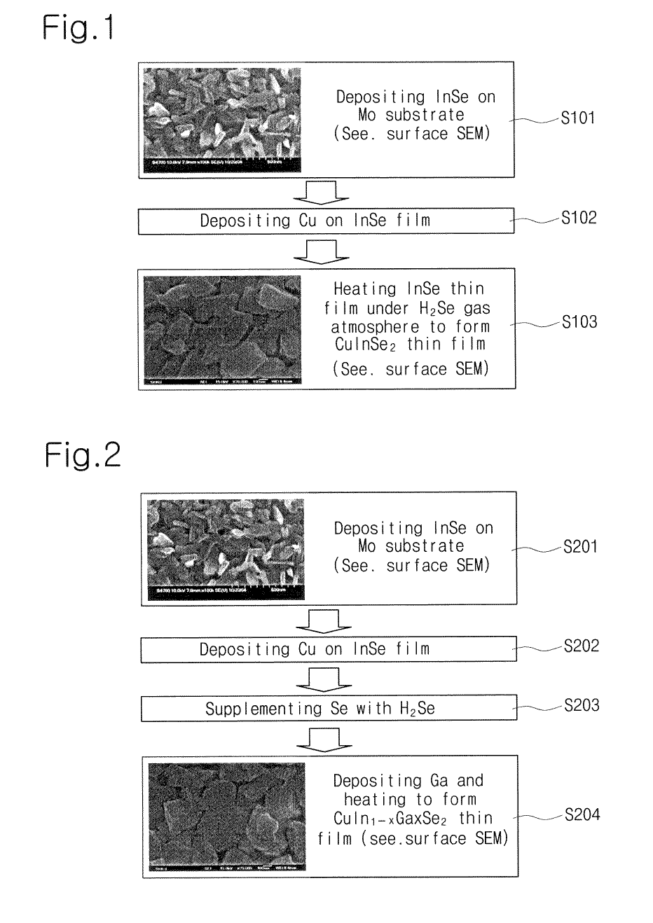

FIG. 1 is a schematic diagram illustrating a production process of a CIS thin film according to one embodiment of the present invention and a scanning electron micrograph (SEM) of the thin film obtained in each step.

As shown in FIG. 1, indium (In) and selenium (Se) were deposited on a Mo substrate by MOCVD using [Me₂In(μ-SeMe)]₂ as a single precursor including indium (In) and selenium (Se) to form an InSe thin film (Step S101).

Copper (Cu) was deposited on the InSe thin film by MOCVD using (hfac)Cu(DMB) as a monovalent Cu precursor to form a Cu—In—Se compound thin film (Step S102). The deposition was carried out at a substrate temperature as low as 200° C.

The Cu—In—Se compound thin film was heated under a H₂Se gas atmosphere to form a CuInSe₂ thin film (Step S103).

### Example 2

A bubbler, in which [Me₂In(μ-SeMe)]₂, (hfac)Cu(DMB) and [Me₂Ga(μ-SeMe)]₂ precursors are included, and a H₂Se gas feeder were sequentially mounted to a low-pressure MOCVD system. On operating the bubbler and the gas feeder, a CIGS thin film was produced in the following process.

FIG. 2 is a schematic diagram illustrating a production process of a CIGS thin film according to another embodiment of the present invention and a scanning electron micrograph (SEM) of the thin film obtained in each step.

As shown in FIG. 2, an InSe thin film was formed in the same manner as in Example 1 (Step S201), copper (Cu) was deposited on the InSe thin film using (hfac)Cu(DMB) (Step S202) and the resulting thin film was heated under a H₂Se gas atmosphere to form a CuInSe₂ thin film (Step S203).

[Me₂Ga(μ-SeMe)]₂ as a precursor including Gallium (Ga) and selenium (Se) was deposited on the CuInSe₂ thin film to form a CuIn₁₋ₓGaₓSe₂ thin film (Step S204).

### Experimental Example

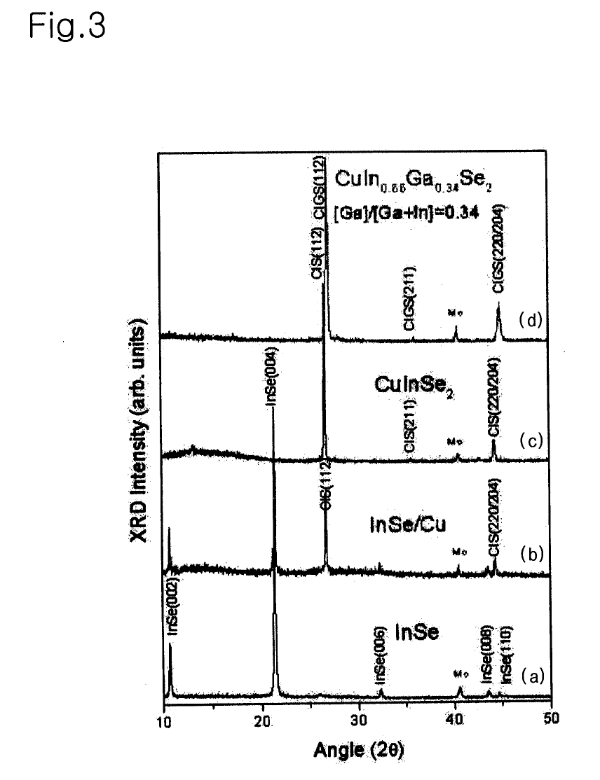

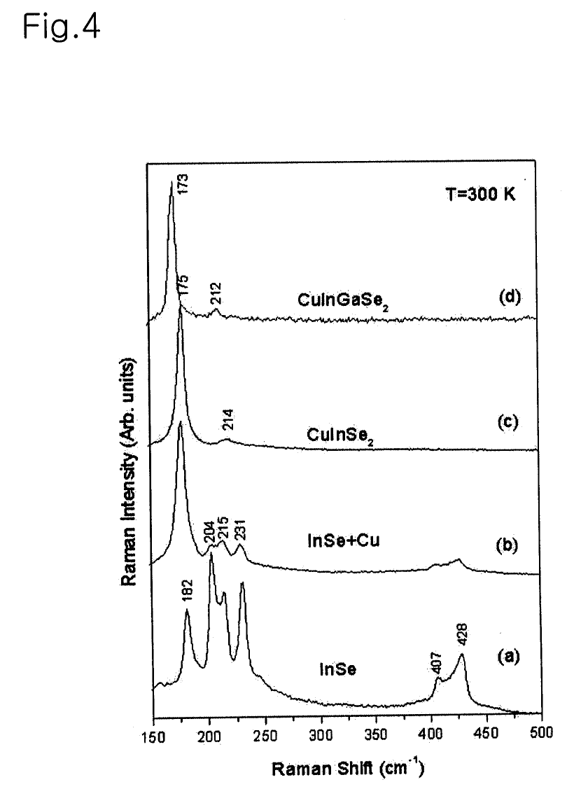

FIGS. 3 and 4 show X-ray diffraction (XRD) patterns and Raman spectra of the thin films formed in Examples 1 and 2, respectively.

FIG. 3 shows analysis results of X-ray diffraction (XRD) of the thin films sequentially formed according to Examples of the present invention, specifically, (a) is XRD patterns of an InSe thin film, (b) is XRD patterns of a thin film obtained by depositing Cu on the InSe thin film, (c) is XRD patterns of a CuInSe₂ thin film obtained by heating the thin film (b) under a H₂Se gas atmosphere, and (d) is XRD patterns of a CuIn_{0.66}Ga_{0.34}Se₂ thin film obtained by depositing GaSe on the thin film (c).

As shown in FIG. 3, in the XRD (a) of the InSe thin film, the peaks at 2θ=10.68°, 21.46°, 32.37° and 43.58° are diffraction patterns obtained by (002), (004), (006) and (008) planes, respectively, and the peak at 2θ=44.69° is a diffraction pattern obtained by a (110) plane. (c) is a XRD pattern peak of the CuInSe₂ thin film, and more specifically, the peaks at 2θ=26.77° and 35.74° are diffraction patterns obtained by (112) and (211) planes, respectively, and the peak at 44.42° is a diffraction pattern obtained by a (220/204) plane. In (b), the InSe XRD peak and the CuInSe₂ XRD peak coexist. This means that when only Cu is fed on the InSe thin film, the InSe thin film is partly converted to the CuInSe₂ thin film. (d) is XRD patterns of the CuIn_{0.66}Ga_{0.34}Se₂ thin film, the peaks at 2θ=27.05° and 2θ=36.07° are diffraction patterns obtained by (112) and (211) planes, respectively, and the peaks at 2θ=44.97° is a diffraction pattern obtained by a (220/204) plane. The diffraction angles of these peaks were shifted to high values, as compared to CuInSe₂. This is the reason that an In atom is partly replaced with a relatively smaller-size Ga atom and a lattice distance is thus decreased. The lattice constant calculated from CuInSe₂ diffraction patterns was a=5.77 Å and c=11.54 Å, which is consistent with the results obtained by Gryunova.

The peaks at 2θ=44.49° observed in all XRD patterns are derived from the Mo substrate.

FIG. 4 is Raman spectra of the thin films formed according to Examples of the present invention, and specifically, (a) is Raman spectra of an InSe thin film, (b) is Raman spectra of a thin film obtained by depositing Cu on the InSe thin film, (c) is Raman spectra of a CuInSe₂ thin film obtained by heating the thin film (b) under a H₂Se gas atmosphere, and (d) is Raman spectra of a CuIn_{0.66}Ga_{0.34}Se₂ thin film obtained by depositing GaSe on the thin film (c).

As shown in FIG. 4, in the Raman spectra (a), the peaks at 182 cm⁻¹ and 231 cm⁻¹ are nonpolar E″ and A₁′ (2) modes, respectively, the peaks at 204 cm⁻¹ and 215 cm⁻¹ are polar E′ transverse optical (TO) and longitudinal optical (LO) modes, respectively, and the peaks at 407 cm⁻¹, 428 cm⁻¹ are E′ (2TO) and 2E′ (2LO), both of which are multi-phonon modes, respectively. (c) is Raman spectra of CuInSe₂, and the peaks at 175 cm⁻¹ and 214 cm⁻¹ are an A₁ mode and the highest B2 (TO) mode, respectively, according to Tamino et. al. Similar to the results of XRD patterns, the InSe Raman peak and CuInSe₂ Raman peak coexist in (c), which means when only Cu is fed on the InSe thin film, the InSe thin film is partly converted to the CuInSe₂ thin film. (d) is Raman spectra of the CuIn_{0.66}Ga_{0.34}Se₂ thin film. The peaks at 173 cm⁻¹ and 212 cm⁻¹ are an A₁ mode and the highest B2 (TO) mode, respectively. These phonon energies are shifted to lower values, as compared to CuInSe₂. This is the reason that an In atom is partly replaced with a relatively smaller-size Ga atom and the vibrational energy of the corresponding lattice vibration mode is thus decreased.

The present invention has been explained in more detail with reference to preferred examples. However, these examples are not to be construed as limiting the scope of the invention. Specifically, although production processes of thin films composed of CuInSe₂ and CuIn₁₋ₓGaₓSe₂ compounds (wherein 0≦x≦1) as a compound thin film used for solar cell light-absorbing layer were illustrated in the examples, these compound thin films are composed of exemplary I-III-VI₂ compounds selected from Group I, III and VI elements of the Periodic Table and are not to be construed as limiting the scope of the invention.

As apparent from the foregoing, according to the present invention, a substantial stoichiometric ratio of a high-quality I-III-VI₂ compound thin film can be produced without unnecessary waste of a Group III element, and a light-absorbing layer for a solar cell can thus be economically and efficiently obtained. In particular, since the formation of a CuInSe₂ thin film exemplified above is carried out under a H₂Se gas atmosphere, the present invention is effective in reducing production time and costs, and minimizing Induim (In) loss which may be occurred in the formation of a CuInSe₂ thin film according to the prior arts issued to the present applicant.

1. A method for producing a light-absorbing layer for a solar cell by forming a I-III-VI₂ compound thin film on a substrate comprising:
(a) depositing a single precursor including Group III and VI elements on a substrate by metal organic chemical vapor deposition (MOCVD) to form a Group III-VI or III₂-VI₃ compound thin film;
(b) depositing a precursor including a Group I element on the III-VI or III₂-VI₃ compound thin film by MOCVD to form a I-III-VI compound thin film composed of Group I, III and VI elements; and
(c) heating the I-III-VI compound thin film under a Group VI element-containing gas atmosphere or depositing a Group VI element-including precursor on the I-III-VI compound thin film by MOCVD to form an I-III-VI₂ compound thin film.

2. The method according to claim 1, wherein the Group I element is Cu or Ag, the Group III element is selected from In, Ga and Al, and the Group VI element is Se, Te and S.

3. The method according to claim 2, wherein the Group VI element-containing gas in step (c) is selected from gases having a structure of H₂E wherein E is a Group VI chalcogen element selected from Se, S and Te.

4. The method according to claim 2, wherein the Group VI element-including precursor in step (c) is selected from precursors having a structure of R₂E wherein R is C₁-C₆ alkyl and E is a Group VI chalcogen element selected from S, Se and Te.

5. The method according to claim 1, wherein the precursor in step (b) is selected from precursors including monovalent Cu as the Group I element.

6. The method according to claim 5, wherein the precursor in step (a) is selected from precursors having a structure of [R₂M(μ-ER′)]₂, wherein M is a Group III metal element selected from In, Ga and Al; R and R′ are each independently C₁-C₆ alkyl; E is a Group VI chalcogen element selected from S, Se and Te; and μ indicates a double bridge between M and E.

7. The method according to claim 1, further comprising:
(d) depositing a single precursor including a Group III′ or VI′ element different from the Group III or VI element of the single precursor used in step (a) on the I-III-VI₂ compound thin film formed in step (c) by MOCVD to form a I-III₁₋ₓ-III′ₓ-VI₂, I-III-(VI_{1-y}VI′_{y})₂, or I-III_{1-y}III′ₓ-(VI_{1-y}VI′_{y})₂ compound thin film wherein x and y are 0≦(x,y)≦1.

8. The method according to claim 7, wherein the precursor in step (d) is selected from precursors having a structure of [R₂M(μ-ER′)]₂, wherein M is a Group III metal element selected from In, Ga and Al; R and R′ are each independently C₁-C₆ alkyl; E is a Group VI chalcogen element selected from S, Se and Te; and μ indicates a double bridge between M and E.

9. The method according to claim 8, wherein the precursor in step (b) is selected from precursors including monovalent Cu as the Group I metal.

10. The method according to claim 9, wherein the precursor in step (a) is selected from precursors having a structure of [R₂M(μ-ER′)]₂ wherein M is a Group III metal element selected from In, Ga and Al; R and R′ are each independently C₁-C₆ alkyl; E is a Group VI chalcogen element selected from S, Se and Te; and μ indicates a double bridge between M and E.

11. The method according to claim 1, further comprising:
(d) depositing a precursor including only a Group III′ element different from the Group III element of the single precursor used in step (a) on the I-III-VI₂ compound thin film formed in step (c) by MOCVD to form a I-III₁₋ₓIII′ₓ-VI₂ (0≦x≦1) compound thin film.

12. The method according to claim 11, wherein the precursor in step (d) is selected from precursors having a structure of R₃M (wherein R is C₁-C₆ alkyl and M is a Group III metal element selected from In, Ga and Al).

13. The method according to claim 12, wherein the precursor in step (b) is selected from precursors including monovalent Cu as the Group I metal.

14. The method according to claim 13, wherein the precursor in step (a) is selected from precursors having a structure of [R₂M(μ-ER′)]₂ wherein M is a Group III metal element selected from In, Ga and Al; R and R′ are each independently C₁-C₆ alkyl; E is a Group VI chalcogen element selected from S, Se and Te; and μ indicates a double bridge between M and E.

15. The method according to claim 1, further comprising:
(d) depositing a precursor including only a Group VI′ element different from the Group VI element of the single precursor used in step (c) on the I-III-VI₂ compound thin film formed in step (c) by MOCVD to form a I-III-(VI_{1-y}VI′_{y})₂ (0≦y≦≦1) compound thin film.

16. The method according to claim 15, wherein the precursor in step (d) is selected from precursors having a structure of R₂E wherein R is C₁-C₆ alkyl and E is a Group VI chalcogen element selected from S, Se and Te.

17. The method according to claim 16, wherein the precursor in step (b) is selected from precursors including monovalent Cu as the Group I metal.

18. The method according to claim 17, wherein the precursor in step (a) is selected from precursors having a structure of [R₂M(μ-ER′)]₂, wherein M is a Group III metal element selected from 1n Ga and Al; R and R′ are each independently C₁-C₆ alkyl; E is a Group VI chalcogen element selected from S, Se and Te; and μ indicates a double bridge between M and E.
